(19) United States
(12) Patent Application Publication
(10) Pub. No.: US 2005/0058794 A1
(43) Pub. Date: Mar. 17, 2005

(54) Sheet material, gas filling type ball and glove

(75) Inventors: Michinori Fujisawa, Okayama (JP); Yoshio Ishihara, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Co., Ltd., Kurashiki-shi (JP)

(21) Appl. No.: 10/937,778

(22) Filed: Sep. 10, 2004

(30) Foreign Application Priority Data
Sep. 12, 2003 (JP) 2003-321891

(51) Int. Cl. F16L 1/00

(52) U.S. Cl. 428/35.7; 428/143

(57) ABSTRACT

A sheet material having polymer layer over the surface of base fabric, the polymer layer comprises a primary outwardly projecting pebbles and a secondary pebbles & valleys over the primary outwardly projecting pebbles, wherein an average height difference (A) of the primary pebbles is 50 to 1000 μm, a projected area of the upper surface of the primary pebbles is 1 to 300 mm², an average height difference (B) of the secondary pebbles & valleys is 5 to 200 μm, an average distance between the pebbles each other of the secondary pebbles & valleys is 100 to 500 μm, and A≧B. A gas filling type ball, a basketball and a glove using the sheet material. Materials for sporting balls such as basketball, American football, Rugby ball, handball, etc., or as the material for gloves having enough mechanical strength, excellent handling property and sufficient surface abrasion resistance are provided.

### TECHNICAL FIELD

The present invention relates to a sheet material, a gas filling type ball covered with the sheet material and a glove. Particularly, the present invention relates to a sheet material having sufficient surface abrasion resistance and favorable non-slip property by forming secondary pebbles and valleys over the upper surface of primary outwardly projecting pebbles. Further, it relates to a gas filling type ball such as basketball, etc., covered with the sheet material. Furthermore, it relates to a glove formed with the sheet material.

### BACKGROUND ART

Hitherto, for the purpose of using as cover materials for gas filling type balls, particularly for gas filling type balls for sports, a number of leather-like sheets for ball materials have been proposed as a substitute for natural leathers. Especially, when balls are employed for sports touched by human's hands many times, non-slip properties are required for almost all the ball materials in many cases. Accordingly, various kinds of method are proposed as a method for obtaining leather-like sheets having the non-slip property.

For example, a method of coating over a surface of various base fabrics including artificial leathers with a coating composition containing a polyurethane resin having hydroxyl groups in its molecule, a liquid rubber having hydroxyl groups in its molecule, an inorganic or organic filler, and an isocyanate prepolymer respectively as a composition for forming a film capable of applying non-slip properties (Japanese Examined Patent Publication No. Hei 7-30285, pages 2 and 3). The film obtained by the invention is appropriately balancing non-slip property, film strength, wet feeling and so on by applying a coating composition blending a polyurethane resin having hydroxyl groups in its molecule or a liquid rubber having hydroxyl groups in its molecule, however, the film cannot absorb water content exceeding the order of sweat although it absorbs a few water content. Accordingly, although the film reveals non-slip property against dry surface such as a human's hand without sweat, it does not stably reveal non-slip property against wet surface such as a human's hand with sweat, and it is not suitable for long-term continuous use. Moreover, a composition with water content of sweat absorbed even only a small amount not only becomes plasticized and the original hand feel is lost, but also takes a lot of time before recovering the original hand feel at the start of using, and accordingly, the film obtained by the above invention is not suitable for long-term continuous use or repeating use with intervals of a short time.

In another proposed method, an anti-slipping material formed by impregnating a nonwoven fabric with a coagulated elastomeric resin and by slicing along its intermediate layer (Japanese Utility Model Application Laid-Open No. Shou 63-197475, pages 2 and 3). The anti-slipping material reveals non-slip property by utilizing the resistance of nap obtained by slicing in addition to rubbery elastic property or foaming structure, and its absorption of large amount of water enables to stably reveal non-slip property even against wet articles, however, it fails to withstand the use under severe conditions, particularly, as in basketball game, etc., because it not only exhibit a low surface strength basically but also tends to easily stain.

In still another proposed synthetic leather material, the surface of a heat-foamed product made from a synthetic rubbery elastic material incorporated with gelatin is made into a porous structure by removing a part of its surface skin layer and then removing gelatin by hot water from the surface (Japanese Patent Application Laid-Open No. Shou 63-152483, pages 2 and 3). The above synthetic leather material is also not suitable as materials for covering balls that requires durability because it specifies foaming structure similarly as the above anti-slipping material and lacks surface abrasion resistance.

Japanese Patent Application Laid-Open No. 2003-193377 discloses synthetic leather obtainable by laminating porous urethane resin film with pebbles and valleys of many fine pores over at least one surface of a base fabric on pages 2 to 4. Over the outwardly projecting pebbles of the above synthetic leather, fine pebbles and valleys that are finer than the above pebbles and valleys are formed. Although the synthetic leather is obtained by transferring pebbles and valleys from a release paper, the fine pebbles and valleys formed over the outwardly projecting pebbles originate from a porous structure obtained by adopting water-soluble inorganic fine particles replacing gelatin in the synthetic leather. Accordingly, it is also poor in surface abrasion resistance and basically tends to easily stain. Moreover, the porous structure itself does not contribute to non-slip property because it is formed of many fine pores with diameters of 15 μm or smaller for the purpose of designing effect such as matt, etc. Accordingly, it does not achieve superior property such as durability or non-slip property.

There has been also proposed a leather-like sheet for balls which comprises a porous base layer made of a fiber-entangled fabric, a porous elastomer and a penetrating agent and a porous surface layer formed thereon. Many microholes with diameters of 100 μm or smaller exist on the porous surface layer and the penetrating agent is present in microholes (Japanese Patent Application Laid-Open No. 2000-328465, pages 2 and 3). Still further, U.S. Pat. No. 6,024,661 proposes a sweat-absorbing game ball comprising a polyurethane-impregnated fibrous material and an outer coating of wet-coagulated polyurethane thereon (pages 4 and 5). The surface of the outer coating includes a plurality of projecting pebbles and valleys therebetween. A plurality of openings is formed on the side surfaces of the pebbles. Because many microholes caused by the porous structure exist on the surface of these materials, even an idea of boring openings only the side surfaces of the outward protrusion (pebbles) cannot improve insufficient surface strength or the structure easily deposited by dirt similarly as the foregoing synthetic leather. Moreover, a non-slip property improved by absorbing water content of sweat, etc., reduces its effect extraordinarily by tighter and tighter adhesion of dirt after long-term use and such drawbacks also unfit for the long-term use.

Still further, Japanese Patent Application Laid-Open No. Hei 9-87974 discloses a leather-like sheet comprising a substrate layer and a napped surface formed over the substrate layer, wherein the napped surface has holes continuing with the interior. A resin for applying non-slip property typically represented by styrene-isoprene block copolymer or its hydrogenated compound is proposed on pages 2 and 3 to be discontinuously applied to the napped surface. The leather-like sheet is provided by applying the foregoing composition for a film capable of adding non-slip property to the napped surface of the substrate layer having a similar structure with the foregoing anti-slipping material, and because the resin having non-slip property is applied discontinuously so as not impairing water absorption inherently, the non-slip property induced by the resin stably reveals for even wet articles. However, because dirt still extraordinarily tend to adhere to the proposed leather-like sheet, not only the reduction of non-slip property caused by the adhesion of dirt is extreme but also the surface strength such as abrasion resistance is insufficient, and accordingly, the leather-like sheet is not suitable as the covering material for balls in view of durability.

Taking the foregoing circumstances into consideration, developments of sheet materials and balls for sports both having sufficient surface abrasion resistance and favorable non-slip property were desired for a long time.

Under such circumstances, an object of the present invention is to provide a sheet material suitably employable for balls, particularly such as American football, basketball, handball and Rugby ball, or for gloves each free from slip and having a sufficient abrasion resistance and mechanical strength. Another object of the present invention is to provide a gas filling type ball covered with the above sheet material and a glove formed with the above sheet material.

### SUMMARY OF THE INVENTION

As a result of extensive researches in view of the above object, it was found that forming fine pebbles that match with the fingerprints of human's hand grasping the ball over the surface of the sheet materials with sufficient mechanical strength and excellent handling property enables to provide balls for sports revealing non-slip property. The sheet material thus formed was also found to be very practical as a sheet material for gloves. The present invention has been accomplished on the basis of the foregoing findings and information.

Namely, the present invention provides:
(1) a sheet material having polymer layer over the surface of base fabric, the polymer layer comprises a primary outwardly projecting pebbles and a secondary pebbles & valleys over the primary outwardly projecting pebbles, wherein an average height difference (A) of the primary pebbles is 50 to 1000 μm, a projected area of the upper surface of the primary pebbles is 1 to 300 mm², an average height difference (B) of the secondary pebbles & valleys is 5 to 200 μm, an average distance between the pebbles each other of the secondary pebbles & valleys is 100 to 500 u m, and A≧B;
(2) a gas filling type ball covered by the sheet material described in the above term (1);
(3) a basketball covered by the sheet material described in the above term (1); and
(4) a glove formed with the sheet material described in the above term (1).

### BRIEF DESCRIPTION OF THE DRAWINGS

FIGS. 1 and 2 are schematic plan view showing embodiments of the secondary pebbles and valleys in the sheet materials of the present invention, whose straight lines correspond to outwardly projecting pebbles of the secondary pebbles and valleys.

FIG. 3 is schematic plan view showing one embodiment of the secondary pebbles and valleys in the sheet materials of the present invention, whose circles correspond to valleys of the secondary pebbles and valleys.

FIGS. 4 and 5 are schematic plan view showing embodiments of the secondary pebbles and valleys in the sheet materials of the present invention, whose black portions correspond to outwardly projecting pebbles of the secondary pebbles and valleys.

FIGS. 6 to 8 are schematic plan view showing embodiments of the secondary pebbles and valleys in the sheet materials of the present invention, whose black portions correspond to valleys of the secondary pebbles and valleys.

### THE MOST PREFERRED EMBODIMENT TO CARRY OUT THE INVENTION

The base fabric employed for sheet materials of the present invention is not particularly specified, and various base fabrics such as natural leather, knitted or woven fabric, or nonwoven fabric and so on are usable. In the case where the knitted or woven fabric, nonwoven fabric and so on is employed as the base fabric, it may be impregnated with an elastic polymer, if necessary. Conventionally known leather-like sheet substrates may be usable as the fiber-entangled fabric without particular limitations. Among these, leather-like sheet substrates comprising fiber-entangled fabric and elastic polymer are preferable, and three-dimensionally entangled nonwoven fabrics of microfine fibers impregnated with a spongy elastic polymer are particularly preferable. These results in improvement of the non-slip property because the secondary pebbles and valleys free from slip and existing over the surface of the sheet materials easily match with the fingerprints of human's hand grasping the ball, provide soft touch and feel, and reveal rebound in certain degrees.

Any fiber selected from conventionally known natural fiber, synthetic fiber, or semisynthetic fiber is employable as a fiber composing the knitted or woven fabric, nonwoven fabric, and so on for the base fabric under the condition that it satisfies mechanical property required as cover materials for balls or gloves. Publicly known cellulose fibers, acrylic fibers, polyester fibers, polyamide fibers or so are preferably employed singly or in combination of two or more taking quality stability, costs, and so on into industrial consideration. In the present invention, although not specified particularly, microfine fibers capable of realizing soft feel closer to natural leathers are suitable. Preferred are microfine fibers having an average fineness of desirably 0.3 dtex or less, more desirably 0.0001 to 0.1 dtex.

The microfine fibers may be produced by (a) a method of directly spinning microfine fibers having an intended average fineness, or (b) a method of first spinning microfine fiber-forming fibers having a fineness larger than the intended fineness and then converting the microfine fiber-forming fibers into microfine fibers having the intended average fineness.

In the method (b) of utilizing the microfine fiber-forming fibers, the microfine fibers are generally formed from composite-spun or mix-spun fibers of two or more kinds of incompatible thermoplastic polymers by removing at least one polymer component by extraction or decomposition, or by dividing or splitting along the boundary between the component polymers. Examples of the microfine fiber-forming fibers of the type to remove at least one polymer component include so-called “sea/island fibers” and “multi-layered fibers”.

By removing the sea component polymer from the sea/island fibers or removing at least one layer component polymer from the multi-layered fibers by extraction or decomposition, a bundle of microfine fibers made of the remaining island component is obtained. Examples of the microfine fiber-forming fibers of the type to be divided or split along the boundary between the component polymers include so-called petaline-like joined-type fibers and multi-layered fibers, which are divided or split along the boundary between layers of different polymers into a bundle of microfine fibers either by mechanical or chemical after treatment.

As the island component polymer for the sea/island fibers, preferred are spinnable polymers capable of exhibiting sufficient fiber properties such as tenacity and having a melt viscosity higher than that of the sea component polymer under spinning conditions and a large surface tension. Examples of the island component polymer include polyamides such as nylon-6, nylon-66, nylon-610 and nylon-612; polyamide-based copolymers; polyesters such as polyethylene terephthalate, polypropylene terephthalate, polytrimethylene terephthalate and polybutylene terephthalate; and polyester-based copolymers.

As the sea component polymer, preferred are polymers having a melt viscosity lower than that of the island component polymer, showing dissolution and decomposition behaviors different from those of the island component polymer, having a higher solubility in a solvent or decomposer for removing the sea component, and having a low compatibility with the island component. Examples of suitable sea component polymers include polyethylene, modified polyethylene, polypropylene, polystyrene, modified polystyrene, and modified polyesters.

The microfine fiber-forming fibers of sea/island type that are particularly suitable for forming microfine fibers having a fineness of 0.3 dtex or less have a sea/island ratio of 30/70 to 70/30 by volume, and preferably 40/60 to 60/40 by volume. When the volume ratio of the sea component is less than 30%, the resultant leather-like sheet is not sufficiently soft and flexible because the amount of the component to be removed by dissolution or decomposition using a solvent or decomposer is too small, requiring the use of a treating agent such as softening agent in an excess amount. However, the use of an excess amount of the treating agent is unfavorable because it may cause various problems such as deterioration in mechanical properties such as tear strength, unfavorable interaction with other treating agents, unpleasant touch or feel, and poor durability. When the proportion of the sea component exceeds 70%, the amount of microfine fibers is too small to ensure stable production of the leather-like sheet having mechanical properties sufficient for the materials of balls. In addition, since the amount of the component to be removed by dissolution or decomposition is too much, problems such as variability of quality due to insufficient removal and disposal of removed components are unavoidable. Therefore, it is not industrially desirable to allow the volume ratio outside the above range in view of improving the productivity with respect to production speed, production costs, etc.

The method of producing the three-dimensionally entangled nonwoven fabric suitably used for forming the fiber-entangled fabric is not particularly restricted, and any suitable known methods are usable as long as the intended weight and density of balls are attained. Either nonwoven fabric of staples or nonwoven fabric of filaments fibers may be employable. A method for forming web may be any known methods such as carding, paper-making and spun-bonding. The web is entangled by various known methods such as needle-punching and spun-lacing, singly or in combination.

Since the fiber-entangled fabric (base fabric) having a weight and density suitable as the material for balls is produced, the three-dimensionally entangled nonwoven fabric is preferably produced in the present invention by the following method. Spun fibers are drawn at a draw ratio of about 1.5 to 5 times, mechanically crimped, and then cut into staples of about 3 to 7 cm long. They are then carded and made into a web having a desired density by passing through a webber. Two or more webs are stacked to have a desired weight and needle-punched at a density of about 300 to 4,000 punches/cm² using a single- or multi-barb needle to entangle fibers in the thickness direction.

Next, the precursor for the fiber-entangled fabric such as the three-dimensionally entangled nonwoven fabric may be impregnated with an elastomeric polymer, if necessary. A solution or dispersion of the elastomeric polymer is impregnated into the precursor for the fiber-entangled fabric by any known methods such as dip-nipping, knife-coating, bar-coating, roll-coating, lip-coating and spray-coating either in single or combined manner, and then dry- or wet-coagulated into a spongy structure having a number of voids. Known elastomeric polymers that have been generally used for the production of leather-like sheets may be used in the present invention. Examples of preferred elastomeric polymers include polyurethane resins, polyester elastomers, rubber resins, polyvinyl chloride resins, polyacrylic acid resins, polyamino acid resins, silicone resins, modified products thereof, copolymers thereof, and mixtures thereof.

After impregnated into the precursor for the fiber-entangled fabric in the form of an aqueous dispersion or a solution in organic solvent, the elastomeric polymer is made into the spongy structure mainly by a dry-coagulation for the aqueous dispersion or by a wet-coagulation for the solution in organic solvent. It is preferred to add a heat-sensitive gelling agent into the aqueous dispersion, because the elastomeric polymer is coagulated uniformly in the thickness direction by a dry-coagulation, optionally in combination with steaming, far infrared heating, etc. The solution in organic solvent is used preferably in combination with a coagulation modifier to form uniform voids. By coagulating the elastomeric polymer impregnated into the fiber-entangled fabric, especially impregnated into the three-dimensionally entangled nonwoven fabric, into the spongy structure, a substrate having a natural leather-like feel and various properties suitable as the materials for balls or gloves is finally obtained.

In view of well-balanced feel and well-balanced properties of the resultant fiber-entangled fabric, polyurethane resins are preferably used in the present invention as the elastomeric polymer.

Typical examples of the polyurethane resins are those produced by the reaction in a predetermined molar ratio of at least one polymer diol having an average molecular weight of 500 to 3,000 selected from the group consisting of polyester diols, polyether diols, polyester ether diols, polylactone diols and polycarbonate diols; at least one organic diisocyanate selected from the group consisting of aromatic, alicyclic and aliphatic diisocyanates such as tolylene diisocyanate, xylene diisocyanate, phenylene diisocyanate, 4,4′-diphenylmethane diisocyanate, 4,4′-dicyclohexylmethane diisocyanate, isophorone diisocyanate and hexamethylene diisocyanate; and at least one chain extender selected from the group consisting of low-molecular compounds having at least two active hydrogen atoms such as diols, diamines, hydroxylamines, hydrazines and hydrazides. These polyurethanes may be used in combination of two or more, or may be used as a polymer composition incorporated with a polymer such as synthetic rubbers, polyester elastomers and polyvinyl chloride.

When the microfine fiber-forming fibers described above are employed, the microfine fiber-entangled fabric (base fabric) impregnated with the elastomeric polymer is obtained by converting the microfine fiber-forming fibers into microfine fibers or bundles of microfine fibers before or after the impregnation and coagulation of the solution or dispersion of the polymeric elastomer. In the case where the conversion is carried out after the impregnation and coagulation of the solution or dispersion of the polymeric elastomer, in other words, at the step of a composite sheet, microfine fiber-forming fibers of the sea/island type forms interstices between the microfine fiber bundles and the elastomeric polymer as a result of removal of the sea component polymer. The interstices weaken the binding of the microfine fiber or the microfine fiber bundles by the elastomeric polymer to make the feel of the fabric substrate softer. Therefore, the microfine fiber-forming treatment is preferably performed in the present invention after the impregnation and coagulation of the elastomeric polymer.

On the other hand, when the impregnation and coagulation of the elastomeric polymer is performed after the microfine fiber-forming treatment, the feel of the fabric substrate may become stiffer because the microfine fiber or the microfine fiber bundles are strongly bound by the elastomeric polymer. However, the tendency to become stiffer can be sufficiently prevented by reducing the proportion of the elastomeric polymer in the base fabric. Therefore, the impregnation and coagulation of the elastomeric polymer after the microfine fiber-forming treatment is preferably employed when a dense and firm feel which is obtained in a higher proportion of the microfine fibers is intended.

The thickness of the base fabric may be selected according to kinds, properties, feel, etc. of aimed balls, and is preferably 0.4 to 3.0 mm although not particularly limited thereto. When the thickness of the base fabric is less than 0.4 mm, it is difficult to ensure the physical properties required as the materials for balls or gloves. On the other hand, even when the thickness of the base fabric exceeds 3.0 mm, there may not particularly be any demerit as materials for balls or gloves; however, it is not favorable because the weights of balls or gloves themselves become heavy.

The mass ratio of the microfine fibers and the elastomeric polymer in the base fabric may be appropriately selected depending on intended properties and feel without particularly specified in the substantial intension of the present invention. The ratio, microfine fibers/elastomeric polymer, is preferably 35/65 to 65/35, more preferably 40/60 to 60/40 by mass when performing the microfine fiber-forming treatment at the step of the composite sheet, and preferably 65/35 to 95/5 by mass, more preferably 60/40 to 90/10 by mass when performing the microfine fiber-forming treatment at the step of the fabric sheet before impregnating and coagulating the elastomeric polymer, in view of obtaining a base fabric having a leather-like feel favorable to the materials for balls or gloves.

Various methods are employable for forming the polymer layer over the surface of the base fabric. For example, by continuously applying a dispersion or solution of an elastomeric polymer over the surface in an amount determined by the clearance between the base fabric surface and a knife, a bar, a roller, etc.; dry- or wet-coagulating the applied elastomeric polymer; and drying may be employed.

In the case where the primary outwardly projecting pebbles or the secondary pebbles and valleys are formed over the polymer layer by means of emboss rollers or flat emboss plate, etc., in the present invention, it is preferable that the polymer layer is porous and that the polymer layer is coagulated and dried by dry process or by wet process. However, in the case where the porous polymer layer is employed, it is preferable that at least on the surface of the primary outwardly projecting pebbles, particularly on the surface of the secondary pebbles and valleys, the porous structure should be protected from being exposed at the final product phase in order to ensure the surface strength such as abrasion resistance and so on at the level required for covering materials for balls. Further, in the case where the secondary pebbles and valleys are formed by transferring process with the use of a gravure roller or a release paper, although not particularly specified, it is preferable that the polymer layer is coagulated and dried by dry process or by wet process in the viewpoints of surface touch and feel. When the dispersion is used, the coagulation and drying are generally successively performed by a dry method with the aid of an additive such as a foaming agent. When the solution is used, it is generally preferred to coagulate the elastomeric polymer into a porous structure in a treating bath after applying a treating solution containing a poor solvent to the elastomeric polymer.

When the base fabric is a fiber-entangled fabric impregnated with elastomeric polymer, it is preferred in the present invention to simultaneously complete the coagulation of the elastomeric polymer impregnated in the base fabric and the coagulation of the elastomeric polymer for forming the porous surface layer (elastomeric polymer layer), because the drying after the coagulation can be completed by only one step, and the base fabric and the porous surface layer (elastomeric polymer layer) are integrally bonded in the resultant leather-like sheet.

Another method for forming the elastomeric polymer layer over the surface of the base fabric includes a step of coating a predetermined amount of a dispersion or solution of the elastomeric polymer on a transfer sheet such as a film or a release paper; a step of coagulating the elastomeric polymer to a porous structure and drying it in the same manner as described above to obtain a porous film; a step of integrally bonding the porous film to the base fabric through a adhesive or by coating a treating solution containing a good solvent for the elastomeric polymer on the porous film to re-dissolve the elastomeric polymer; and a step of peeling off the transfer sheet. The dispersion or solution of the elastomeric polymer coated on the transfer sheet may be bonded to the base fabric before or during the coagulation of the elastomeric polymer, thereby integrally bonding the porous surface layer to the base fabric simultaneously with the coagulation. Regarding the polymer forming the polymer layer as the surface layer, a resin having non-slip property is preferable, and synthetic rubber, polyester elastomer, polyvinylchloride, polyurethane-based resin, etc., are employable. Among these, polyurethane resins are preferably used as the elastomeric polymer for constituting the porous surface layer, in view of the balance between elasticity, softness, abrasion resistance, ability of forming porous structure, etc.

Typical examples of the polyurethane resins are those produced by the reaction in a predetermined molar ratio of at least one polymer diol having an average molecular weight of 500 to 3,000 selected from the group consisting of polyester diols, polyether diols, polyester ether diols, polylactone diols and polycarbonate diols; at least one organic diisocyanate selected from the group consisting of aromatic, alicyclic and aliphatic diisocyanates such as tolylene diisocyanate, xylene diisocyanate, phenylene diisocyanate, 4,4′-diphenylmethane diisocyanate, 4,4′-dicyclohexylmethane diisocyanate, isophorone diisocyanate and hexamethylene diisocyanate; and at least one chain extender selected from the group consisting of low-molecular compounds having at least two active hydrogen atoms such as diols, diamines, hydroxylamines, hydrazines and hydrazides. These polyurethanes may be used in combination of two or more, or may be used as a polymer composition incorporated with a polymer such as synthetic rubbers, polyester elastomers and polyvinyl chloride. With regard to the polyurethane mainly used, polyether-based polymer diols represented by polytetramethylene glycol are preferably employed in view of hydrolysis resistance, elasticity, etc.

The solution or dispersion of the elastomeric polymer to be applied over the base fabric may optionally contain additives, singly or in combination, such as colorants, light stabilizers and dispersants. In addition, other additives such as a foaming agent for dry foaming and a coagulation modifier for wet-coagulation may be preferably added singly or in combination to control the configuration of porous structure.

When polyurethane is used as the polymer, after coating the base fabric with the solution containing polyurethane as the main ingredient, polyurethane is coagulated into porous structure by immersing the base fabric in a treating bath containing a poor solvent to polyurethane. Although water is preferably used as the typical poor solvent to polyurethane, the use of a treating bath comprising a mixture of water as the poor solvent and dimethylformamide as a good solvent to polyurethane makes it easy to regulate the coagulated state of polyurethane, i.e., the configuration of porous structure and shape of microholes as specified in the present invention by suitably selecting a mixing ratio of the poor and good solvents.

The average height difference (A) between the pebbles and valleys in the primary outwardly projecting pebbles in the polymer layer of the present invention is suitably 50 to 1000 μm and preferably 70 to 500 μm. When the average height difference (A) is smaller than 50 μm, favorable non-slip property is not provided even when the secondary pebbles and valleys are formed over the primary outwardly projecting pebbles because the force of the human's fingertip is dispersed over the surface of the ball in an occasion of grasping the ball with the palm of the human's hand. When the average height difference (A) exceeds 1000 μm, although the non-slip property becomes favorable, abrasion resistance in the occasion of using the sheet material for balls degrades. Additionally, the average height difference (A) in the present invention is defined as the measured value by means of section photography about the height difference between the top of the pebbles and the bottom of the valleys in the primary outwardly projecting pebbles followed by averaging ten points of measured value.

Further, the projected area of the upper surface of the primary outwardly projecting pebbles is 1 to 300 mm², preferably 1 to 100 mm², and more preferably 1 to 50 mm². When the projected area of the upper surface of the primary outwardly projecting pebbles is smaller than 1 mm², although the non-slip property becomes favorable, it becomes difficult to provide sharp secondary pebbles and, at the same time, abrasion resistance in the occasion of using the sheet material for balls degrades. When the projected area of the upper surface of the primary outwardly projecting pebbles exceeds 300 mm², favorable non-slip property is not provided even when the secondary pebbles and valleys are formed over the primary outwardly projecting pebbles because the number of the primary outwardly projecting pebbles grasped by a human's fingertip decreases and the force of the human's fingertip will be uniformly dispersed over the surface of the ball in an occasion of grasping the ball with the palm of human's hand.

The projected area of the upper surface of the primary outwardly projecting pebbles is defined as the projected area (cross-sectional area) at the height of one-third (L/3) from the bottom of the primary outwardly projecting pebbles determining the portion where the height difference of each primary outwardly projecting pebbles is the largest as the highest height (L). In the case where two or more of the primary outwardly projecting pebbles overlap partially, and in the case where the projected area of the overlapped part is 25% or less of the projected area of one primary outwardly projecting pebble, each overlapped primary outwardly projecting pebbles are defined as the primary outwardly projecting pebbles respectively.

The entire projected area of the primary outwardly projecting pebbles is 30 to 85%, preferably 40 to 70% expressed as the area ratio to the whole sheet material.

The primary outwardly projecting pebbles may be formed over the polymer layer of the present invention by any suitable known methods as long as they stably provide the average height difference (A) between the pebbles and valleys in the primary outwardly projecting pebbles is 50 to 1000 μm, and the projected area of the upper surface of the primary outwardly projecting pebbles is 1 to 300 mm², for example, by using an emboss roller, a flat emboss plate or a release paper each having the pebbled pattern. The flat emboss plate is not for continuous process of mass production. The height difference between the pebbles and valleys in the pebbled pattern achieved by the use of the release paper is limited substantially from 200 to 300 μm, and the pebbled pattern may lack sharpness when the height difference is close to the limit. Although such drawbacks can be eliminated by further pressing the release paper from the backside, the feel becomes stiffer because of a large required pressing force. Therefore, it is preferred to form the pattern by the emboss roller having a pebbled pattern suitable.

In the case where the primary outwardly projecting pebbles having the average height difference (A) of 50 to 1000 μm and the projected area of the upper surface of 1 to 300 mm² are formed over the polymer layer with the use of the emboss roller, the condition such as the emboss depth of the roller, the surface temperature of the roller, the emboss pressure and the embossing time may be appropriately settled. Although these conditions are not particularly specified, the desired embossed depth may be obtainable by arranging the emboss depth of the roller within the range from 80 to 1100 μm, the surface temperature of the roller within the range from 150 to 180° C., the embossing pressure within the range from 5 to 50 kg/cm, and the embossing time within the range from 10 to 120 seconds respectively.

The surface of the polymer layer may be colored either before or after the embossing treatment. To avoid the discoloration during the embossing treatment, the coloring treatment is preferably conducted after the embossing treatment. Pigments excellent in heat resistance, light resistance and fastness to rubbing are preferably used as the colorants. The coloring may be performed by known methods such as gravure method, dyeing method, reverse coating method and direct coating method, with gravure method being preferred in view of productivity and costs.

With regard to the pattern of the secondary pebbles and valleys of the present invention, it is preferable to be formed by points or lines disposed on lines or curves each in the direction of two or more such as grating, concentric circles, radial and so on in order to obtain non-slip property uniformly in every directions.

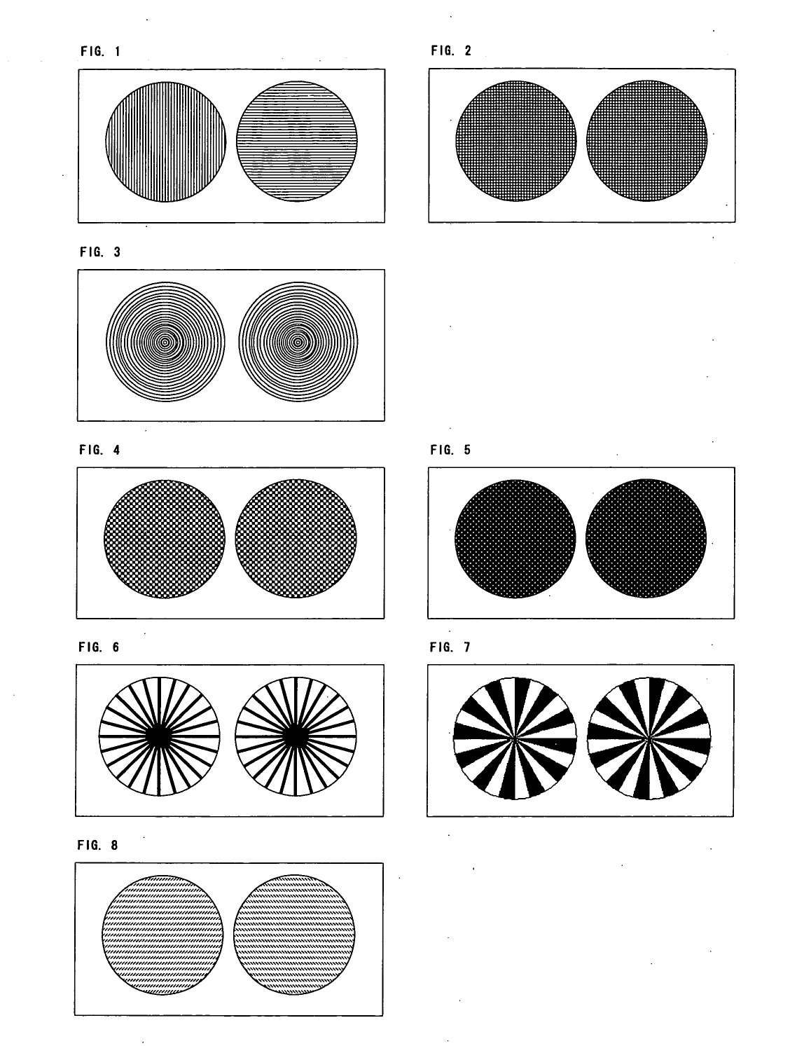

FIGS. 1 to 8 are schematic plan views showing embodiments of the secondary pebbles and valleys in the sheet materials of the present invention. The straight lines in FIGS. 1 and 2 correspond to outwardly projecting pebbles of the secondary pebbles and valleys. The circles in FIG. 3 correspond to valleys of the secondary pebbles and valleys. The black portions in FIGS. 4 and 5 correspond to outwardly projecting pebbles of the secondary pebbles and valleys. The black portions in FIGS. 6 to 8 correspond to valleys of the secondary pebbles and valleys.

The average height difference (B) of the secondary pebbles and valleys is 5 to 200 μm, preferably 10 to 150 μm. When the depth of the secondary pebbles and valleys is shallower than 5 μm, the holding force of human's fingerprint grasping ball becomes poor. When the depth of the secondary pebbles and valleys exceeds 200 μm, sharp pattern of pebbles and valleys become difficult to be provided, and it is not preferable because of the appearance poor in esthetics. Additionally, the average height difference (B) in the present invention is defined as the measured value by means of section photography about the height difference between the top of the pebbles and the bottom of the valleys in the secondary pebbles and valleys followed by averaging ten points of measured value.

Further, the relation between the average height difference (A) and the average height difference (B) of the sheet material is A≧B.

The average distance between the pebbles in the secondary pebbles and valleys is 100 to 500 μm, preferably 110 to 350 μm. When the average distance between the pebbles in the secondary pebbles and valleys is smaller than 100 μm, the distance is too smaller than the fine pebbles and valleys present in fingerprint of the human's hand grasping the ball to obtain favorable non-slip property. When the average distance between the pebbles in the secondary pebbles and valleys exceeds 500 μm, a favorable non-slip property is not obtainable because the holding portion of human's fingerprint grasping ball decreases. With this regard, the distance between the pebbles in the secondary pebbles and valleys in the case where the secondary pebbles and valleys are disposed radially as shown in FIGS. 6 and 7 is defined as the average distance between the maximum distance and the minimum distance over the upper surface of one primary outwardly projecting pebbles.

Similarly as the primary outwardly projecting pebbles, the entire projected area of the secondary pebbles and valleys is 30 to 85%, preferably 40 to 70% expressed as the area ratio to the whole sheet material. When the area ratio to the whole sheet material of the secondary pebbles and valleys is smaller than 30%, a favorable non-slip property is not obtainable because the holding portion of human's fingerprint grasping ball decreases. When the area ratio to the whole sheet material of the secondary pebbles and valleys exceeds 85%, distances between the adjacent primary outwardly projecting pebbles becomes too small to obtain favorable non-slip property because the effect of providing the primary outwardly projecting pebbles eliminates.

Further, in case of the average height difference (A) between the pebbles and valleys in the primary outwardly projecting pebbles within the range from 50 to 1000 μm, the projected area of the upper surface of the primary outwardly projecting pebbles within the range from 1 to 300 mm², the average height difference (B) of the secondary pebbles and valleys within the range from 5 to 200 μm, the average distance between the pebbles in the secondary pebbles and valleys within the range from 100 to 500 μm, and the relation A≧B, the sheet material reveals favorable non-slip property and abrasion resistance even in the case where the sheet material is used for gloves.

The secondary pebbles and valleys may be formed over the upper surface of the primary outwardly projecting pebbles by any suitable known methods, for example, by using an emboss roller, a flat emboss plate, a release paper, or transferring polymer resin with the use of a gravure roller each having a pebbled pattern. In the case where the fine pattern of pebbles are applied with the use of a gravure roller having 150 to 50 mesh (coating amount: 15 to 25 g/m²), and in the case where a coating solution with solids content of 5 to 10% and with viscosity of 0.5 to 2.0 dPa·s usually employed for gravure transfer, the low viscosity makes it difficult to obtain sharp secondary pebbles and valleys stably and, at the same time, the low solid content obstructs stably obtaining a depth of 5 μm or deeper. In order for obtaining sharp secondary pebbles and valleys having depths of 5 μm or deeper, it is necessary to employ a polymer solution with solids content of 20 to 35% and with viscosity of 2.0 to 3.5 dPa·s in order to get sharp secondary pebbles and valleys.

Further, regarding with the pattern of the primary outwardly projecting pebbles, a pattern that gives a feeling of pebbles easily in surface appearance and touch is preferable.

In the present invention, it is possible to apply non-slip property by coating a resin having non-slip property over at least pebbles of the secondary pebbles and valleys. Preferable examples of the resin applying non-slip property include polymer resin of rubber-based monomer such as butadiene and isoprene, solvent-type polymer such as acryl-based polymer polymerizing acrylic monomer and urethane-based polymer, and emulsion-type polymer. Other kinds of polymers may be used in combination with these resins. Further, a block-copolymer of the above monomer and the other monomer may be employable.

Furthermore, well known tackifier such as polyterpene resin, petroleum-based hydrocarbon resin and so on may be added to the resin for applying non-slip property. Moreover, it is possible to adjust non-slip property by adding inorganic or organic particles or powder, etc. Still further, softening agent, fillers, antioxidant and so on may be optionally added to the surface resin in an amount that does not reduce surface frictional resistance.

With regard to a method for coating resin for applying non-slip property, a method for coating not continuously may be employable. Specific examples include a transfer method with the use of gravure roller and a method for coating with a constant thickness over entire surface of the substrate such as spray coating or knife coating. They further include film forming by coating resin or so over entire surface of a substrate such as process paper, followed by bonding the film over a substrate layer via an adhesive layer; and an extrusion film forming method uniformity extruding resin over a substrate layer from an extruder through an extrusion die.

It is a matter of course that the seat material of the present invention has enough mechanical strength, excellent handling property and sufficient surface abrasion resistance. It also reveals favorable non-slip property and, in conclusion, it is preferably suitable as the material for sporting balls such as basketball, American football, Rugby ball, handball, etc., or as the material for gloves. Further, sporting balls covered with the seat material of the present invention and gloves formed with the sheet material of the present invention reveal favorable non-slip property.

### EXAMPLES

The present invention will be described in more detail with reference to the following examples. However, it should be noted that the following examples are only illustrative and not intended to limit the scope of the invention thereto. The “part” and “%” described herein are based on mass unless otherwise specified.

### Example 1

6-Nylon (island component) and a high-fluidity low-density polyethylene (sea component) were melt-spun into sea/island mix-spun fibers (sea component/island component=50/50). The fibers were drawn, crimped and then cut into 51·mm long staples having a fineness of 3.5 dtex. The staples were carded and formed into a web by a cross-lapping method. A stack of webs was needle-punched at a density of 980 punches/cm² using single-barb felt needles to obtain a nonwoven fabric having a mass per unit area of 450 g/m². The nonwoven fabric was heat-dried, pressed to smooth its surface, and impregnated with a 16% dimethylformamide (hereinafter referred to as “DMF”) solution of polyether polyurethane, followed by the coagulation of the impregnated polyurethane in a 20% aqueous solution of DMF. Then, the nonwoven fabric was washed with hot water and the polyethylene in the fibers was extracted and removed by hot toluene to obtain a porous polyurethane-impregnated base fabric made of 6-nylon microfine fibers.

A DMF solution (solid content: 20%) of polyether polyurethane (“MP-105” available from Dainippon Ink & Chemicals, Inc.) was applied onto the surface of the base fabric in a coating amount of 400 g/m², and coagulated in water to form a polymer layer as a porous surface layer on the base fabric. After coloring the porous surface layer with a polyether-based polyurethane ink containing a brown pigment, a pebbled pattern of the primary outwardly projecting pebbles was formed by using an emboss roller for basketballs at a surface temperature of 170° C. under a pressing pressure of 10 kg/cm, with a treating speed of 1 m/minute. The primary outwardly projecting pebbles were circular with diameters of 8 mm having the average height difference (A) of 200 μm, projected area of the upper surface of 2.5 mm², and the entire projected area of the pebbles occupied 50% of the entire area of the substrate. Only the upper surface of the resultant primary outwardly projecting pebbles were colored with the use of ether-based polyurethane ink changing the color tone into black side by adding carbon black preparedly.

Subsequently, the secondary pebbles and valleys were embossed and formed over the resultant sheet with the use of the emboss roller at the surface temperature of 150° C., embossing pressure of 1.5 kg/cm, and the treating speed of 2 m/minute. The secondary pebbles and valleys had average height difference (B) of 15 μm, average distance between the pebbles of 170 μm, and the entire projected area occupied 50% of the entire surface area of the substrate. Polycarbonate-based polyurethane (U-5811, available from SEIKO Chemical Co., Ltd.) as the resin for applying non-slip property was coated over the secondary pebbles and valleys in two steps with the use of 150 mesh gravure roller.

A basketball made by covering with the resultant sheet material gave an impression of appearance in high quality because the valleys and pebbles in the primary pebbles and valleys rendered different color tone, and even after the long-term use in basketball game, it maintained favorable non-slip property. Further, a glove made by using the resultant sheet material had extremely favorable non-slip property.

### Comparative Example 1

A sheet material was produced similarly treating as Example 1 except that the different color tone was not applied over the upper surface of the primary outwardly projecting pebbles and that the secondary pebbles and valleys were not applied. A basketball made by covering with the resultant seat material was very slippery in practical use.

### Comparative Example 2

A sheet material was produced similarly treating as Example 1 except that the secondary pebbles and valleys were not applied. Although the resultant sheet material revealed wet feel on the surface, a basketball using the material was slippery in practical use and the non-slip property was insufficient.

### Comparative Example 3

A sheet material was produced similarly treating as Example 1 except that only the secondly pebbles and valleys were applied without applying the primary outwardly projecting pebbles and valleys and that the different color tone was not applied over the upper surface of the secondary outwardly projecting pebbles. Although the resultant sheet material revealed wet feel on the surface, a basketball using the material was very slippery in practical use and the non-slip property was insufficient.

### Comparative Example 4

A sheet material was produced similarly treating as Example 1 except that the speed of embossing treatment was 4 m/minute and the average height difference of the primary outwardly projecting pebbles was 30 μm. Although the resultant property was insufficient.

### Comparative Example 5

A sheet material was produced similarly treating as Example 1 except that the emboss roller was replaced with the roller having average distance of 70 μm between the pebbles of pebbles and valleys. Although the resultant sheet material revealed wet feel on the surface, a basketball using the material was slippery in practical use and the non-slip property was insufficient.

### Example 2

A DMF solution (solid content: 20%) of polyether polyurethane (“MP-105” available from Dainippon Ink & Chemicals, Inc.) was applied onto the surface of the base fabric prepared in Example 1 in a coating amount of 400 g/m², and coagulated in water to form a polymer layer as a porous surface layer on the base fabric. After coloring the porous surface layer with a polyether-based polyurethane ink containing a brown pigment, a pebbled pattern of the primary outwardly projecting pebbles was formed by using an emboss roller for basketballs having wider area of pebbles than Example 1 at a surface temperature of 180° C. under a pressing pressure of 8 kg/cm, with a treating speed of 1.2 m/minute. The primary outwardly projecting pebbles were circular with diameters of 3.8 mm having the average height difference (A) of 170 μm, projected area of the upper surface of 11.1 mm², and the entire projected area of the pebbles occupied 48% of the entire area of the substrate. Only the upper surface of the resultant primary outwardly projecting pebbles were colored with the use of ether-based polyurethane ink changing the color tone into black side by adding carbon black to preparedly colored one.

Subsequently, the secondary pebbles and valleys were embossed and formed over the resultant sheet with the use of the emboss roller at the surface temperature of 150° C., embossing pressure of 1.5 kg/cm, and the treating speed of 2 m/minute. The secondary pebbles and valleys had average height difference (B) of 15 μm, average distance between the pebbles of 170 μm, and the entire projected area occupied 45% of the entire surface area of the substrate. Polycarbonate-based polyurethane (“U-5811”, available from SEIKO Chemical Co., Ltd.) as the resin for applying non-slip property was coated over the secondary pebbles and valleys in two steps with the use of 150 mesh gravure roller.

A basketball made by covering with the resultant sheet material gave an impression of appearance in high quality because the valleys and pebbles in the primary pebbles and valleys rendered different color tone, and even after the long-term use in basketball game, it maintained favorable non-slip property.

Further, a glove made by using the resultant sheet material had extremely favorable non-slip property.

### INDUSTRIAL APPLICABILITY

It is a matter of course that the seat material of the present invention has enough mechanical strength, excellent handling property and sufficient surface abrasion resistance. Because the secondary pebbles and valleys applied over the upper surface of the primary outwardly projecting pebbles match with the fingerprints of human's hand grasping the ball, they reveal favorable non-slip property as compared with the case where only the primary outwardly projecting pebbles exist on the surface. Accordingly, it is preferably suitable as the material for sporting balls such as basketball, American football, Rugby ball, handball, etc., or as the material for gloves. Further, sporting balls covered with the seat material of the present invention and gloves formed with the sheet material of the present invention reveals favorable non-slip property.

1. A sheet material having polymer layer over the surface of base fabric, the polymer layer comprises a primary outwardly projecting pebbles and a secondary pebbles and valleys over the primary outwardly projecting pebbles,
wherein an average height difference (A) of the primary pebbles is 50 to 1000 μm, a projected area of the upper surface of the primary pebbles is 1 to 300 mm², an average height difference (B) of the secondary pebbles and valleys is 5 to 200 μm, an average distance between the pebbles each other of the secondary pebbles and valleys is 100 to 500 μm, and A≧B.

2. The sheet material according to claim 1, wherein said base fabric is leather-like base fabric comprising fiber-entangled fabric and elastic polymer.

3. The sheet material according to any one of claim 1 or claim 2, wherein said base fabric is three-dimensionally entangled nonwoven fabrics of microfine fibers impregnated with a elastic polymer.

4. The sheet material according to claim 1, wherein entire projected area of the secondary pebbles and valleys occupies 30 to 85% of the entire area of the sheet material.

5. The sheet material according to claim 1, wherein a resin composing said polymer layer has non-slip property.

6. The sheet material according to claim 1, wherein a resin having non-slip property is applied onto at least the pebbles of said secondary pebbles and valleys.

7. The sheet material according to claim 1, wherein the upper surface of said primary outwardly projecting pebbles has a color tone different from the valleys.

8. A gas filling type ball covered by the sheet material according to claim 1.

9. A basketball covered by the sheet material according to claim 1.

10. A glove formed with the sheet material according to claim 1.
